(19) United States
(12) Patent Application Publication
(10) Pub. No.: US 2012/0223621 A1
(43) Pub. Date: Sep. 6, 2012

(54) MULTIPURPOSE PORTABLE POWER GENERATING SYSTEM

(76) Inventors: Ki Il KIM, Los Angeles, CA (US); Young K. Kim, Los Angeles, CA (US); Jong Ho Lee, Cerritos, CA (US); Tae Wook Kwon, Rowland Heights, CA (US); Gui Hyeon Moon, Buena Park, CA (US)

(21) Appl. No.: 13/172,377

(22) Filed: Jun. 29, 2011

Related U.S. Application Data
(60) Provisional application No. 61/464,269, filed on Mar. 2, 2011.
(60) Provisional application No. 61/464,617, filed on Mar. 7, 2011.
(60) Provisional application No. 61/464,718, filed on Mar. 8, 2011.
(60) Provisional application No. 61/465,090, filed on Mar. 14, 2011.
(60) Provisional application No. 61/516,103, filed on Mar. 29, 2011.
(60) Provisional application No. 61/516,484, filed on Apr. 4, 2011.
(60) Provisional application No. 61/517,075, filed on Apr. 13, 2011.
(60) Provisional application No. 61/517,412, filed on Apr. 19, 2011.
(60) Provisional application No. 61/517,776, filed on Apr. 25, 2011.

(51) Int. Cl. H02N 2/18

(52) U.S. Cl. 310/339

(57) ABSTRACT

Provided is a system for producing electricity, the system having an object configured to move in at least one of, an upward direction, a downward direction, a left direction, a right direction, an eccentric motion, a straight line, or a circular motion; and at least one piezoelectric element attached to the object, wherein, when the object is moving, the object is configured to apply a pressing force to the at least one piezoelectric element to produce the electricity.

### CROSS-REFERENCE TO RELATED APPLICATIONS

This application claims benefit under 35 U.S. C. Section 119(e) of U.S. Provisional Application Ser. No. 61/464,269, filed Mar. 2, 2011, U.S. Provisional Application Ser. No. 61/464,617, filed Mar. 7, 2011, U.S. Provisional Application Ser. No. 61/464,718, filed Mar. 8, 2011, U.S. Provisional Application Ser. No. 61/465,090, filed Mar. 14, 2011, U.S. Provisional Application Ser. No. 61/516,103, filed Mar. 29, 2011, U.S. Provisional Application Ser. No. 61/516,484, filed Apr. 4, 2011, U.S. Provisional Application Ser. No. 61/517,412, filed Apr. 19, 2011, U.S. Provisional Application Ser. No. 61/517,075, filed Apr. 13, 2011, and U.S. Provisional Application Ser. No. 61/517,776, filed Apr. 25, 2011, the entire disclosures of which are hereby incorporated by reference in their entireties.

### BACKGROUND OF THE INVENTION

1. Field of the Invention

The present invention relates a method and a system in which a plurality of piezoelectric elements or a plate to which the piezoelectric element is attached is installed in machinery in motion so that the piezoelectric element can produce electricity by applying a pressing force or shock to the piezoelectric element or the plate to which the piezoelectric element is attached.

2. Description of the Related Art

In emergency situations such as, for example, a motor breakdown or a water outage, there is a need to generate power mechanically or manually.

In a piezoelectric device, pressure is directly or indirectly (e.g., using vibration) applied to a piezoelectric element. In various applications, a piezoelectric material is used for energy conversion from electrical into mechanical and vice versa. However, an amount of electrical charge produced by the piezoelectric device is typically low.

Some of the piezoelectric elements in the prior art are disclosed in U.S. Pat. No. 7,239,066, U.S. Pat. No. 7,511,404, and U.S. Pat. No. 4,316, 413.

It is known that a direct pressure type piezoelectric element can produce electrical energy several to hundreds of times more than a vibration type piezoelectric element.

The present invention utilizes such characteristics of the piezoelectric element to produce maximum amount of current in a manual or mechanical manner.

### SUMMARY OF THE INVENTION

The present invention has been made in view of the above problems, and provides a method and a system in which a plurality of piezoelectric elements or a plate to which the piezoelectric element is attached is installed in machinery that moves upward, downward, to the left or right, or moves eccentrically, in a straight line or circular curve, by using natural power, man-made electricity, or gas so that the piezoelectric element can produce electricity by applying pressure or shock to the piezoelectric element or the plate to which the piezoelectric element is attached upward or downward, to the left or right, or continuously when the piezoelectric element or the plate is rotating. In addition, the electricity can be automatically produced by using a sensor, and stored in a battery or utilized in various applications.

Also, the present invention utilizes the movement of an object such as, for example, an eccentric motion or a straight line motion in applying pressure or vibration. Additionally, the present invention allows a user to select whether to apply pressure or vibration. In a method of applying direct pressure to the piezoelectric element, when the piezoelectric element receives a force greater than a predetermined threshold, a spring can be used to absorb an excessive force to prevent the piezoelectric element from breaking apart.

A drawer type power generator system can be provided as built-in furniture such as, for example, a desk, a PC table, or a tea table at home or at school or as a separate table. A vibrator, which is operated manually or by a motor to move in a straight line, can be positioned between an upper piezoelectric plate and a lower piezoelectric plate so that electricity can be produced when the furniture moves forward, backward, to the left or right. Also, the piezoelectric element can be attached to a rear face of a drawer of the drawer type power generator system so that electricity can be produced when pressure is applied thereto.

Further, the present invention can automatically turn on or turn off the system by using a sensor as well as allow a user to choose an option for Tx-Rx channel so that the user can monitor the system through wireless communication.

In one aspect of the present invention, provided is a system for producing electricity, the system comprising: an object configured to move in at least one of, an upward direction, a downward direction, a left direction, a right direction, an eccentric motion, a straight line, or a circular motion; and at least one piezoelectric element attached to the object, wherein, when the object is moving, the object is configured to apply a pressing force to the at least one piezoelectric element to produce the electricity.

In one or more embodiments of the present invention, the object has a shape of one of, a polygon or a circle.

In one or more embodiments of the present invention, the system for producing electricity further comprises a spring attached to the at least one piezoelectric element, wherein, when the at least one piezoelectric element receives the pressing force that is greater than a threshold level, the spring absorbs an excessive force.

In one or more embodiments of the present invention, the system for producing electricity further comprises a gear connected to the object, wherein, when the object is moving, a rotation ratio of the gear is controlled to increase or decrease a rotational speed of the object.

In one or more embodiments of the present invention, the system for producing electricity further comprises a sensor configured to automatically turn on or turn off the system.

In another aspect of the present invention, provided is a system for producing electricity, the system comprising: a first plate; at least one piezoelectric element attached to the first plate; a vibrator; and a second plate attached to the vibrator, wherein the second plate is positioned above or below the first plate and is configured to move in at least one of, a forward direction, a backward direction, a left direction, or a right direction such that the vibrator is configured to apply a pressing force to the at least one piezoelectric element to produce the electricity.

In one or more embodiments of the present invention, the second plate comprises a roller, and wherein the second plate is configured to move in at least one of, the forward direction, the backward direction, the left direction or the right direction by using the roller.

In one or more embodiments of the present invention, the second plate is configured to move by a manual or mechanical operation.

In one or more embodiments of the present invention, the system for producing electricity further comprises a handle attached to the second plate and configured to enable the manual operation of the second plate.

In one or more embodiments of the present invention, the first plate comprises a pin type electrical printed circuit board (PCB), and the at least one piezoelectric element is attached or detached to/from the PCB of the first plate.

In one or more embodiments of the present invention, the system for producing electricity further comprises a control box having a battery configured to store the produced electricity.

In one or more embodiments of the present invention, the control box has a sensor to monitor a battery level, and when the battery level is lower than a predetermined threshold level, the system is configured to automatically turn on to produce the electricity.

In one or more embodiments of the present invention, the system for producing electricity further comprises at least one power connector jack configured to discharge the produced electricity.

In one or more embodiments of the present invention, the control box includes a central processing unit configured to automatically control an electric power level of the battery such that, when the electric power level of the battery is lower than a predetermined level, a red light emitting diode (LED) light is turned on, a warning sound is generated, and the battery starts charging.

In one or more embodiments of the present invention, at least one of, a text, an e-mail, or a voice message is sent to a mobile phone or a reachable device designated by a user to notify the user that the battery is being charged.

In one or more embodiments of the present invention, when charging of the battery is completed, the central processing unit is configured to turn on a green LED light.

In one or more embodiments of the present invention, at least one of, a text, an e-mail, or a voice message is sent to a mobile phone or a reachable device designated by a user to notify the user that the charging of the battery is completed.

In one or more embodiments of the present invention, the system for producing electricity further comprises a power drawer main box configured to receive the first plate; and a motor connected to the power drawer main box through a connecting rod, wherein, when the motor is driven, the power drawer main box is caused to move with respect to the second plate, thereby applying at least one of a pressure, an impact or a vibration to the piezoelectric element that is attached to the first plate.

In still another aspect of the present invention, provided is a system for producing electricity, the system comprising: a first needle disk; a second needle disk; a motor; a disk roller positioned between the first needle disk and the second needle disk, the disk roller being connected with the motor; and a piezoelectric element attached to the first needle disk and the second needle disk, wherein, when the disk roller is rotated by an operation of the motor, a pressure is applied to the piezoelectric element to produce the electricity.

In one or more embodiments of the present invention, the system for producing electricity further comprises a sensor configured to automatically turn on or turn off the system.

In one or more embodiments of the present invention, the piezoelectric element is positioned perpendicular to a rotation axis such that the first needle disk and the second needle disk, the disk roller and the piezoelectric element are rotated together.

In still another aspect of the present invention, provided is a system for producing electricity, the system comprising: an upper plate; a lower plate; a motor; a piezoelectric element attached to the upper plate and the lower plate; a cam disk positioned between the upper plate and the lower plate, the cam disk being connected to the motor; and a needle bearing positioned on an end portion of the cam disk, wherein the needle bearing presses the piezoelectric element to produce the electricity when the motor is rotated.

In one or more embodiments of the present invention, the system for producing electricity further comprises a spring positioned on the upper plate and the lower plate, the spring being configured to control a pressure level applied thereto.

In one or more embodiments of the present invention, the system for producing electricity further comprises a sensor configured to automatically turn on or turn off the system.

In still another aspect of the present invention, provided is a system for producing electricity, the system comprising: a piezoelectric element configured to be installed on a road or sidewalk; and a spring configured to be positioned between the piezoelectric element and the road or the sidewalk to increase a vibration force applied to the piezoelectric element when the road or the sidewalk is pressed by a vehicle or a pedestrian.

In still another aspect of the present invention, provided is a system for producing electricity, the system comprising: a motor; a centrifugal disk having a centrifugal groove and is connected to a rotation axis of the motor; a centrifugal outer ring; a needle roller positioned on the centrifugal disk, wherein the needle roller is moved along the centrifugal groove when the motor is rotated; and a piezoelectric element positioned on the centrifugal outer ring, wherein a pressing force is applied to the piezoelectric element by a rolling motion of the needle roller to generate electricity.

In still another aspect of the present invention, provided is a system for producing electricity, the system comprising: an outer ring; piezoelectric elements; a turret disk; a turret outer ring located in the center of the outer ring, wherein the piezoelectric elements are arranged on the turret outer ring along a circumference of the turret outer ring and the piezoelectric elements are positioned at a constant distance from each other both toward the outer ring and toward the turret outer ring; and a needle roller located at a predetermined distance on the turret disk, wherein the needle roller is rotated by a motor to vibrate the piezoelectric elements, thereby generating the electricity.

In still another aspect of the present invention, provided is a method of producing electricity, the method comprising: providing a piezoelectric element; providing an object that is configured to move in at least one of, an upward direction, a downward direction, a left direction, a right direction, an eccentric motion, a straight line, or a circular motion, connecting the piezoelectric element to the object; moving the object such that a pressing force is applied to the piezoelectric element; and producing electricity.

In still another aspect of the present invention, provided is a method of producing electricity, the method comprising: providing a piezoelectric element; providing an object that is configured to move in at least one of, an upward direction, a downward direction, a left direction, a right direction, an eccentric motion, a straight line, or a circular motion, connecting the piezoelectric element to the object; moving the object such that a pressing force is applied to the piezoelectric element; and producing electricity.

In one or more embodiments of the present invention, the method of for producing electricity further comprises providing an outer ring having an inner wall; installing the piezoelectric element on the inner wall of the outer ring; and moving the outer ring in an eccentric rotary motion.

In one or more embodiments of the present invention, the method of for producing electricity further comprises storing the produced electricity in a battery.

In one or more embodiments of the present invention, the method of for producing electricity further comprises providing a number of gear teeth configured to rotate the object, wherein, when the object moves in the circular motion, the number of gear teeth is adjusted to increase or decrease a rotational speed of the object to control an amount of the produced electricity.

In one or more embodiments of the present invention, the object is moved by using hydroelectric power.

In one or more embodiments of the present invention, the object is moved by using wind power.

In one or more embodiments of the present invention, the method of for producing electricity further comprises providing a sensor; and automatically detecting, by using the sensor, an amount of electricity consumption to control an operation of the object.

### BRIEF DESCRIPTION OF THE DRAWINGS

The objects, features and advantages of the present invention will be more apparent from the following detailed description in conjunction with the accompanying drawings, in which:

FIG. 1 is a perspective view illustrating a power generating system according to an exemplary embodiment of the present invention:,

FIG. 2 is a side view illustrating the power generating system according to the exemplary embodiment of the present invention;

FIG. 3 is a plan view illustrating the power generating system according to the exemplary embodiment of the present invention;

FIG. 4 is a cross-sectional view taken along line A-A of the power generating system according to the exemplary embodiment of the present invention;

FIG. 5 is a cross-sectional view taken along line B-B of the power generating system according to the exemplary embodiment of the present invention;

FIG. 6 is a cross-sectional view illustrating a needle bearing piezo disk according to an exemplary embodiment of the present invention;

FIG. 7 is a cross-sectional view illustrating a needle bearing disk according to an exemplary embodiment of the present invention;

FIG. 8 is a perspective view illustrating the needle bearing disk according to the exemplary embodiment of the present invention;

FIG. 9 is a front view illustrating a power generating system with a direct pressure type piezoelectric element using a cam according to an exemplary embodiment of the present invention;

FIG. 10 is a perspective view illustrating the power generating system with a direct pressure type piezoelectric element using a cam according to the exemplary embodiment of the present invention;

FIG. 11 is a perspective view illustrating a drawer type power generator system according to an exemplary embodiment of the present invention;

FIGS. 12A-12C are another perspective views illustrating the drawer type power generator system according to the exemplary embodiment of the present invention;

FIG. 13 is a view illustrating a central processing unit (CPU) of a system control box according to an exemplary embodiment of the present invention;

FIG. 14 is a perspective view illustrating a power generating system according to another exemplary embodiment of the present invention;

FIG. 15A is a side view illustrating a piezo plate according to an exemplary embodiment of the present invention;

FIG. 15B is a front view illustrating the piezo plate according to the exemplary embodiment of the present invention;

FIG. 15C is a perspective view illustrating the piezo plate according to the exemplary embodiment of the present invention;

FIG. 16A is a front view illustrating a connection between an outer ring and a piezo plate according to an exemplary embodiment of the present invention;

FIG. 16B is a perspective view illustrating the connection between the outer ring and the piezo plate according to the exemplary embodiment of the present invention;

FIG. 17 is a perspective view illustrating a hydroelectric power plant according to an exemplary embodiment of the present invention;

FIG. 18 is a perspective view illustrating a wind power plant according to an exemplary embodiment of the present invention;

FIG. 19 is a configuration view illustrating a power generator used in a vehicle according to an exemplary embodiment of the present invention;

FIG. 20 is a schematic view illustrating a power generator system using a sensor buried inside a road according to an exemplary embodiment of the present invention;

FIG. 21 is a perspective view illustrating a foot press type power generator according to an exemplary embodiment of the present invention;

FIG. 22A is a view illustrating a piezoelectric element configured for installation in a road or sidewalk according to an exemplary embodiment of the present invention;

FIG. 22B is a view illustrating an example in which a piezoelectric element is installed in a road according to an exemplary embodiment of the present invention;

FIG. 22C is a view illustrating an example in which a piezoelectric element is installed in a sidewalk according to an exemplary embodiment of the present invention;

FIG. 23 is a perspective view illustrating a power generating system using a needle roller according to still another exemplary embodiment of the present invention;

FIG. 24 is a cross sectional view illustrating the power generating system using the needle roller of FIG. 23;

FIG. 25 is a perspective view illustrating the needle roller according to the exemplary embodiment of the present invention;

FIG. 26 is a perspective view illustrating a power generating system using a centrifugal force according to still another exemplary embodiment of the present invention;

FIG. 27 is a cross sectional view illustrating the power generating system using the centrifugal force of FIG. 26;

FIG. 28A is a front view illustrating a centrifugal plate according to an exemplary embodiment of the present invention;

FIG. 28B is a perspective view illustrating the centrifugal plate according to the exemplary embodiment of the present invention;

FIG. 29 is a perspective view illustrating a portable power generator using a turret according to still another exemplary embodiment of the present invention;

FIG. 30A is a front view illustrating an outer ring of the turret of FIG. 29 according to an exemplary embodiment of the present invention;

FIG. 30B is a side view illustrating the outer ring of the turret according to the exemplary embodiment of the present invention;

FIG. 31 is a perspective view illustrating the outer ring of the turret according to the exemplary embodiment of the present invention;

FIG. 32 is a view illustrating a portable power generator box and a manual handle according to the exemplary embodiment of the present invention; and

FIG. 33 is a view illustrating various applications of a power generator according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

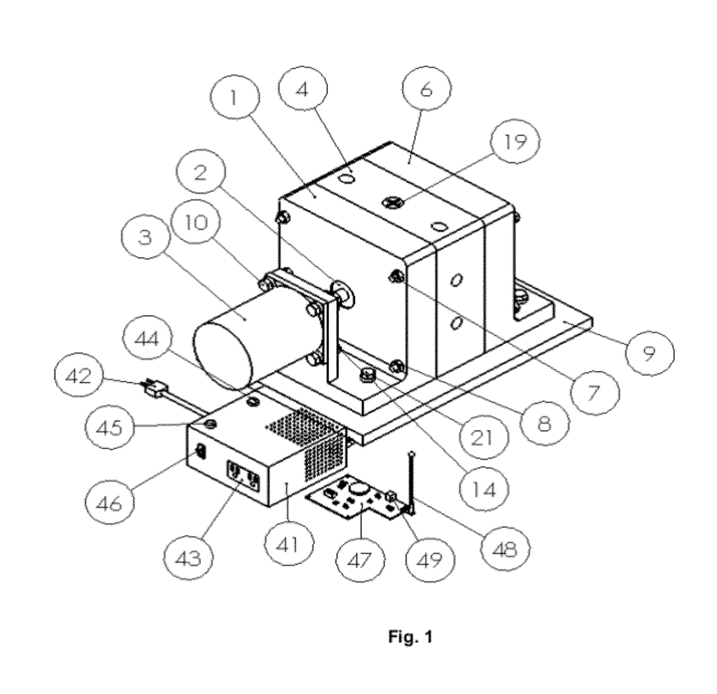

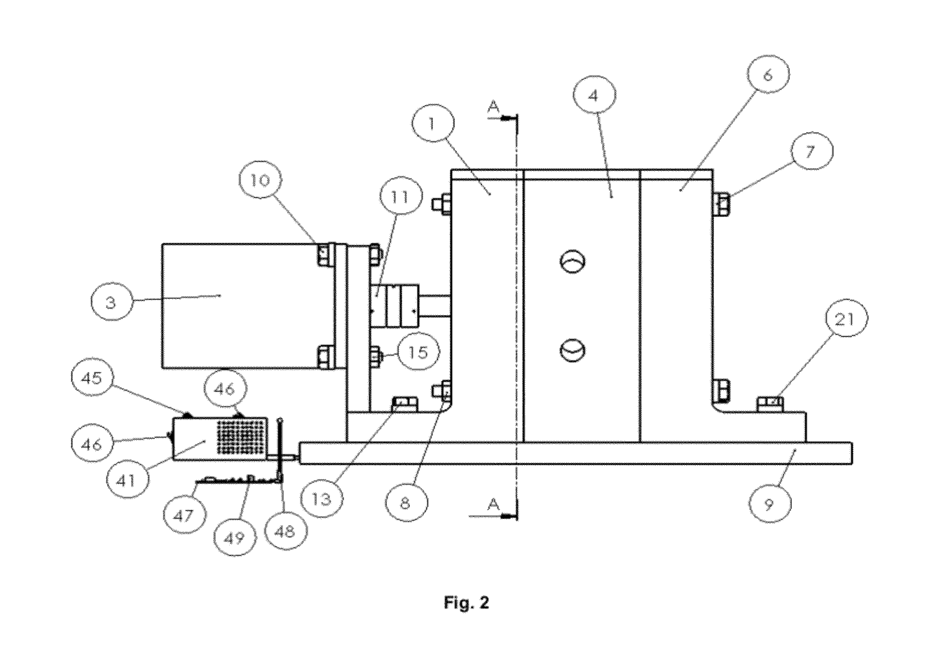

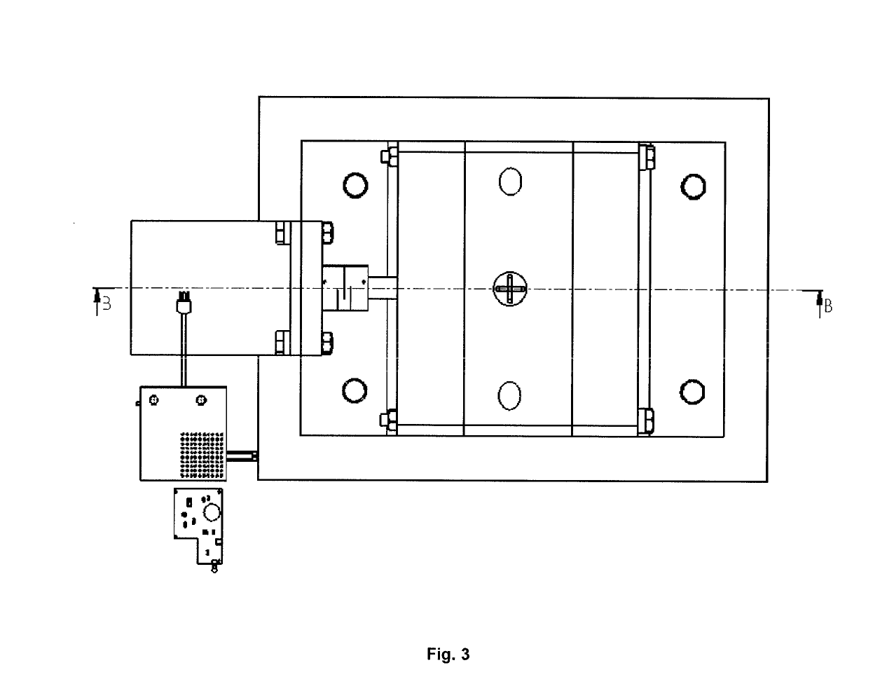

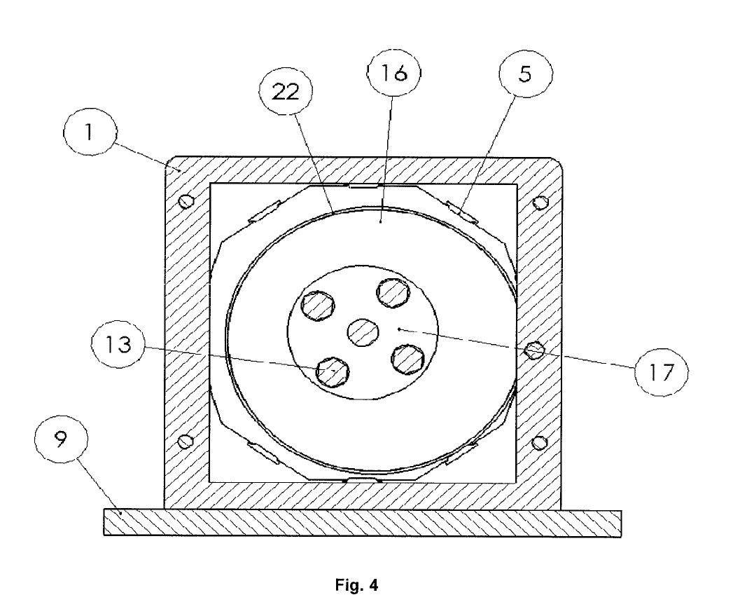

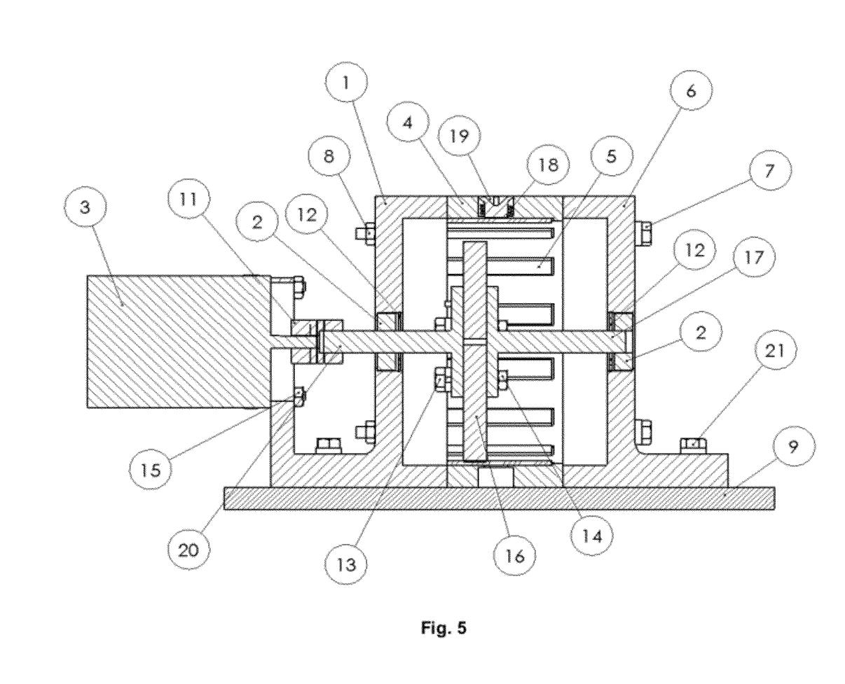

With reference to FIGS. 1-5, when a motor 3 rotates, even when a rotational axis of the motor 3 deviates from an axis of a coaxial axis fixing and internal connecting road 20, smooth rotation of the motor 3 is possible because a coupling 11 absorbs the load of the motor 3. The coaxial axis fixing and internal connecting road 20, an eccentric disk 16, and a coaxial axis fixing and external connecting road 17 are coupled therebetween through a coaxial axis fixing bolt 13 and a coaxial axis fixing nut 14, thereby being assembled with the coupling 11 and a bearing 2. A motor fixing support 1, a piezoelectric element fixing support 4 and a sub fixing support 6 are fixed and assembled together by using a first fixing bolt 7 and a first fixing nut 8. The motor 3 is fixed to the motor fixing support 1 by using a motor fixing bolt 10 and a motor fixing nut 15. When connecting the coaxial axis fixing and external connecting road 17 with the motor fixing support 1, a snap ring 12 can be used to reduce attrition therebetween and secure the coaxial axis fixing and external connecting road 17. The piezoelectric element fixing support 4 is assembled with a piezoelectric element 5, a piezoelectric element fixing spring 18 and a spring fixing bolt 19. Finally, when a lower fixing support 9 and an upper assembled body are assembled with a lower portion fixing bolt 21, the assembly of the system is completed.

When the motor 3 rotates, a central axis of the coaxial axis fixing and internal connecting road 20 becomes coaxial with a central axis of the eccentric disk 16 to move in a wave like motion. In this case, an urethane outer ring 22 can be used to surround the eccentric disk 16 to protect the eccentric disk 16 from impact with the piezoelectric element 5 while reducing rotating sound thereof Thus, a force is directly applied to the piezoelectric element 5. Also, the motor 3 is driven by a sensor located within a control box and is automatically controlled to turn on or turned off by the sensor depending on a battery power level. The produced electricity is charged in the battery or used in various applications. Further, an option for Tx-Rx channel can be selected to wirelessly monitor the operation of the system. In addition, a switch 46 can be used to switch to a manual operation of the motor 3.

In a drawer type power generator system (or a power drawer) where the piezoelectric element or a plate to which the piezoelectric element is attached is positioned on a lower plate thereof or the piezoelectric element is adhered to a rear wall of a drawer thereof, electricity is produced when an upper part of a vibration plate is moved by, for example, one inch to the left or right, or forward or backward, electrically or mechanically by using a human hand or a motor. The produced electricity can be charged in a battery for future use or provided to a connector for DC-AC conversion to be output through an AC outlet. Also, when needed, the system can be operated manually.

The piezoelectric element can be easily attached or detached to/from a pin type electrical printed circuit board (PCB) of the lower plate or an upper plate of the drawer type power generator system or the plate to which the piezoelectric element is attached. Therefore, it is possible to control the number of the piezoelectric element to obtain a desired amount of electricity.

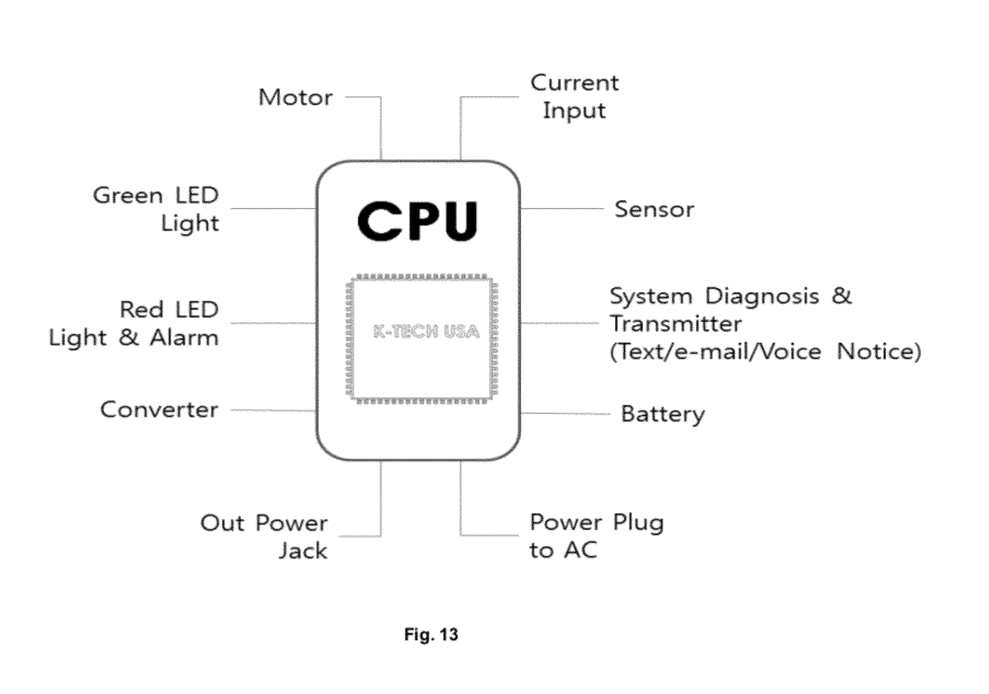

In addition, a central processing unit (CPU) of FIG. 13 that is built in a system control box automatically controls electric power such that, when the electrical power of the system needs to be charged, a red LED light is turned on, a warning sound is generated, and power begins charging. Also, when the option for the TX/RX channel is selected, a text, an e-mail or a voice message can be sent to a mobile phone designated by a user or any other reachable device to notify the user of the system being charged. When the power charge of the system is completed, a green LED light is turned on, and a text, an e-mail or a voice message is sent to the mobile phone designated by the user or any other reachable device to notify the user of the completion of the power charge of the system. Thus, the user can monitor an operational state of the system at any time and from any place, while the user has an option to determine whether to operate the system, depending on necessity.

To this end, the control box 41 includes a charge green light 44 for indicating a full battery level, a charge red light 45 for indicating a low battery level, a printed circuit board for the CPU, an antenna, and an external connection jack 47 for internet connection.

A vibration gear is positioned along a central rotation axis of the motor 3 and at least one outer ring is provided. Each outer ring can include at least two piezoelectric elements or any other means for producing electricity. In the exemplary embodiment of the present invention, each outer ring has forty piezoelectric elements attached thereto. When the motor starts rotating, the vibration gear is caused to rotate around the central rotation axis, leading to contact or impact on the piezoelectric element or the plate to which piezoelectric element is attached, wherein the plate is connected to the outer ring. In this manner, the piezoelectric element generates electricity, which is then charged in the battery or discharged through a power outlet at home to be used.

While the motor consumes a small amount of electricity, the piezoelectric element produces a greater amount of electricity and remaining electricity quantity is charged in the battery or used for various purposes.

Also, when a certain amount of electricity is consumed in the system control box, the sensor of the system control box automatically operates the motor to produce the electricity to be charged.

In other words, an automatic electricity producing system is implemented so that an unlimited amount of electricity can be produced without any limitation of space and time. Also, the number of rotations of a motor gear can be increased or decreased by controlling the number of tooth of the motor gear. Further, the amount of electricity produced can vary according to the number of piezoelectric elements attached to the outer ring.

In the exemplary embodiment of the present invention, the piezoelectric element is utilized to produce electricity; however, it should be noted that the present invention applies to any other type of an electricity generating element, now known or in the future developed, to produce electricity by using a motion, e.g., a rotational motion of the machinery.

Thus, the portable power generator according to the present invention can be installed in any kind of mobile unit, whether the mobile unit is in land, sea or air, to produce and utilize electricity.

Especially in a case for an electric car, the present invention solves the problem that the electric car needs to periodically recharge a battery by connecting to an AC power, which can take up to about 5 to 10 hours. Namely, the sensor of the system according to the present invention detects a low power level of the battery and automatically operates the motor to recharge the battery. Thus, the present invention provides a breakthrough in a mobile unit industry as well as in an automobile industry.

In addition, as many of the piezoelectric elements as needed, or a plate to which the piezoelectric element is attached is installed in industrial machinery that is hand or mechanically operated to move upward, downward, to the left or right, or moves eccentrically, in a straight line, or in a circular curve, to produce a desired amount of electricity when pressure or shock is applied to the piezoelectric element upward or downward, to the left or right. Thus, pollution from energy production can be prevented.

Materials consisting of each element of the present invention are described below.

The motor fixing support 1 as shown in FIGS. 1 through 5 preferably comprises a durable material because the motor fixing support 1 directly receives load or impact. For example, metal including iron, which is easy to fabricate, can be utilized. Also, the piezoelectric element fixing support 4, the sub fixing support 6, the lower fixing support 9, and the spring fixing bolt 19 preferably comprise a durable material with strength of a certain level.

The eccentric disk 16 and the coaxial axis fixing and external connecting road 17 preferably comprise a material having higher abrasion resistance, elasticity, and strength to absorb shock from torsional moment.

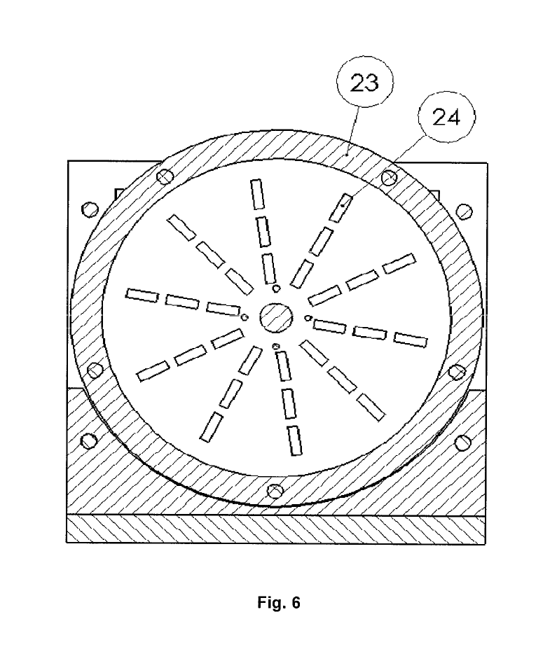

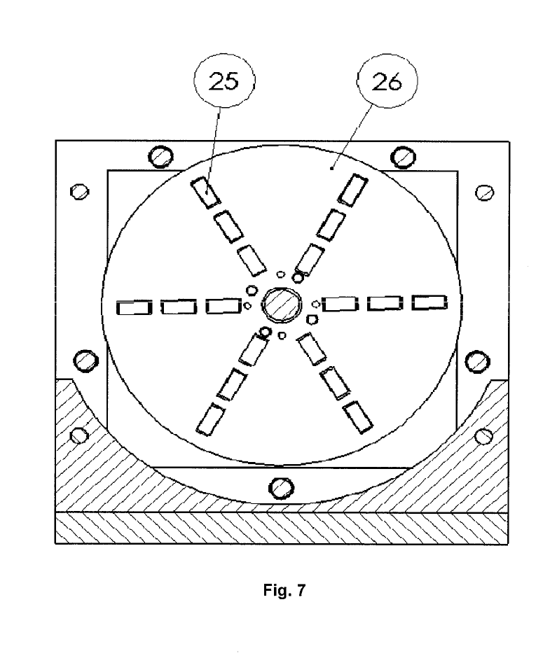

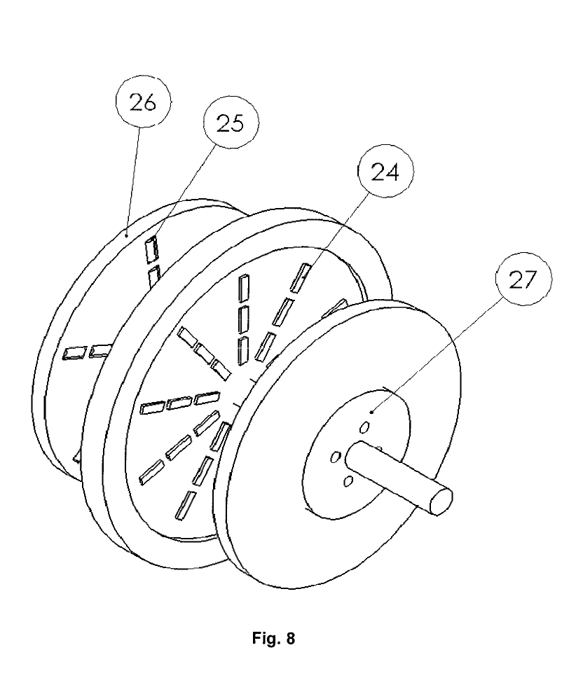

A needle bearing piezo 24 shown in FIGS. 6, 7 and 8 is positioned in a direction perpendicular to the rotation axis of the system, compared to the prior art in which the needle bearing piezo is positioned parallel to the rotation axis. Accordingly, a needle bearing piezo disk 26 and a needle roller 25 rotate along the rotation axis of the system to directly press the needle bearing piezo 24 along a direction perpendicular to the rotation axis. In FIG. 6, the needle bearing piezo 24 is surrounded by a needle bearing piezo outer ring 23. Also, in FIG. 8, a needle bearing piezo disk shaft 27 is used to connect the needle bearing piezo disk 26.

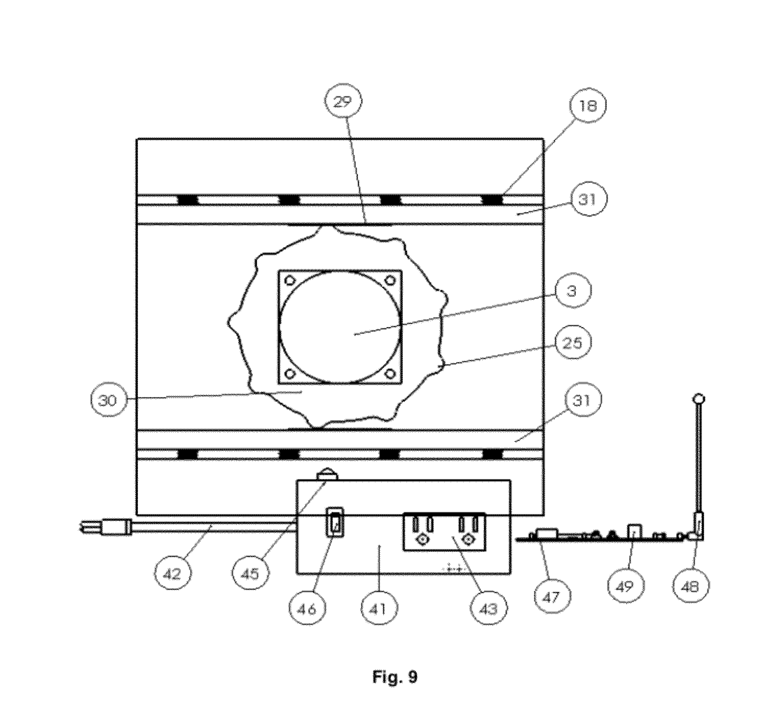

In FIGS. 9 and 10, a piezo 29 is pressed by a cam 30. More specifically, the cam 30 is rotated due to the operation of the motor 3 that touches the piezo 29. In case where a piezoelectric element fixing plate 31 receives a force greater than a predetermined level, a spring 18 can be included to protect the piezo 29. The power generating system of FIG. 10 also includes a cam fixing support 10.

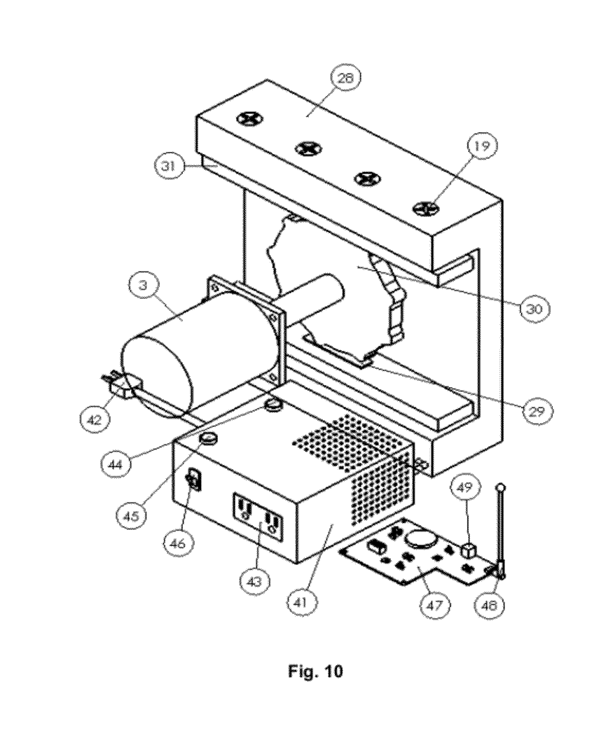

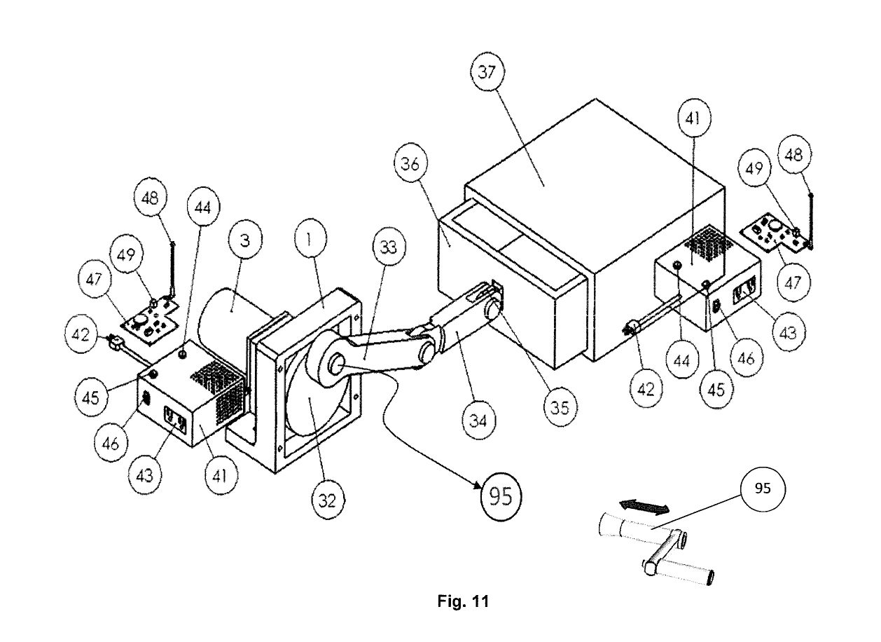

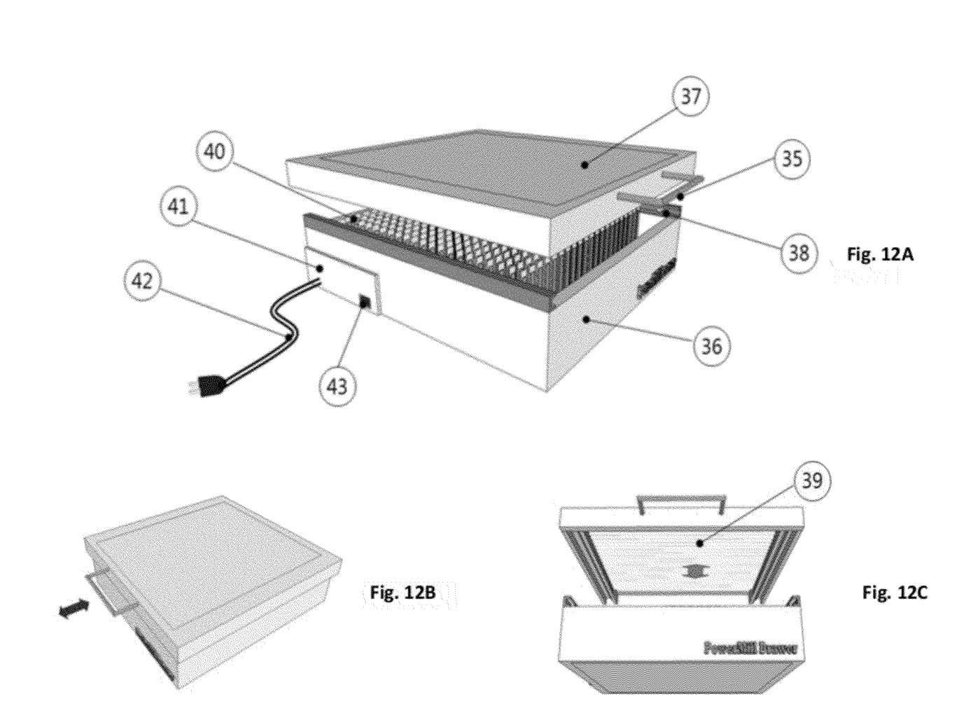

FIGS. 11, 12A-12C and 13 illustrate the drawer type power generator system according to exemplary embodiments of the present invention. In FIG. 11, when the motor 3 is driven, the motor 3 rotates a flywheel 32, of which rotary motion is converted to a linear motion of connecting rods 33 and 34, thereby moving a power drawer main box 36. Alternatively, in an exemplary embodiment shown in FIGS. 12A-12C, a handle 35 can be attached to a power drawer cover top 37 to enable a manual operation. Specifically, the power drawer main box 36 includes a slot to which the piezoelectric element or a plate 40 to which the piezoelectric element is attached can be inserted, and a power control box 41 including a convertor, a battery, a power plug 42, a power jack 43, etc., to control a produced current. Also, a roller 38 can be positioned within the power drawer main box 36 to facilitate the movement of the power drawer cover top 37 with respect to the power drawer main box 36. When the handle 35 attached to the power drawer cover top 37 is manually moved, a vibration plate 39, which is located above the plate 40, contacts or brings impact on the fixed piezoelectric element or the plate 40 to which the piezoelectric element is attached, thereby generating a current. Alternatively, although not shown in the drawings, instead of using the vibration plate 39, a pressing force can be directly applied to the piezoelectric element or the plate 40 to which the piezoelectric element is attached. In addition, the system according to the present invention can include an additional plate in an upper or a lower portion and form a vibrating means between the plates, thereby producing a larger amount of electricity when the vibrating means moves in the linear motion. Further, a method of using vibration can be combined with a method of directly pressing the piezoelectric element to produce multiple times more amount of electricity. An example assembly order of the drawer type power generator system according to the present invention is as follows: the piezoelectric plate 40 is inserted into the slot within the power drawer main box 36 and the control box 41 is attached thereto. The vibration plate 39 is attached to the power drawer cover top 37 and then the power drawer cover top 37 is engaged with the power drawer main box 36.

In the exemplary embodiment of the present invention described above, the vibration plate 39 is driven by an electric power of the motor 39. It should be noted that the vibration plate 39 can also be driven manually. In the example of the power generator according to the exemplary embodiment of the present invention using the eccentric disk, the needle bearing, the cam, or the drawer, the control box 41 has a sensor automatically turn on or turn off the motor based on sensor detection. When the motor is driven, electricity can be generated. The power generator according to the present invention can be installed in any type of industrial machinery that has a motion or any mobile unit for the purpose of electricity generation.

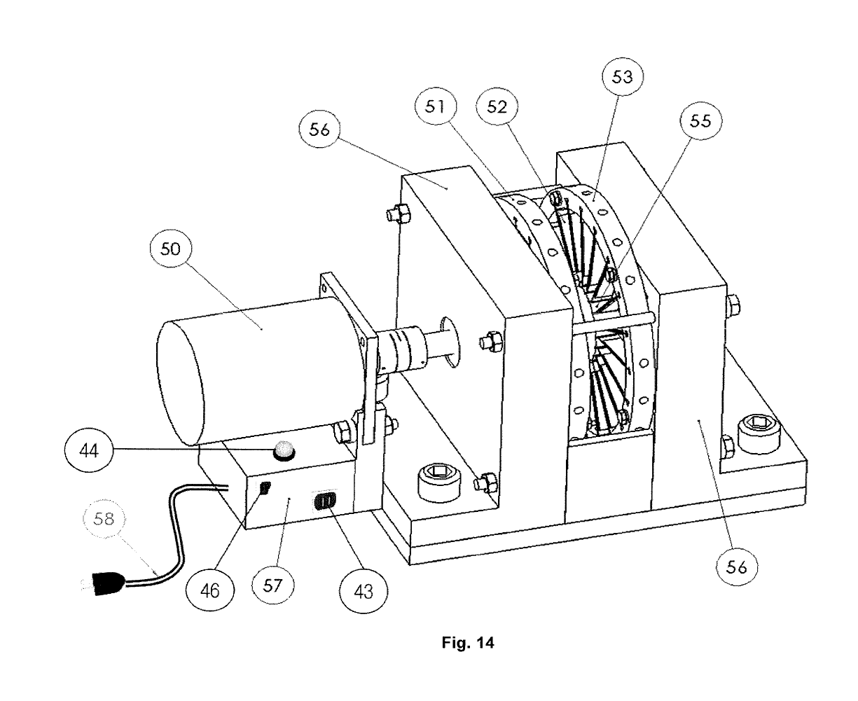

FIG. 14 shows the portable power generator that includes two outer rings 51 and 53, a piezoelectric plate 52 to which a piezoelectric element is attached to, an outer ring holder 56 for holding the outer rings 51 and 53, a gear vibrator 55 for applying a pressure to the piezoelectric plate 52, a motor 50 for driving the gear vibrator 55, and a power control box 57 including the CPU, the battery, the built-in sensor, the convertor, the power jack, and a diagnosis lamp. Respective elements of the power generator are engaged with each other and assembled.

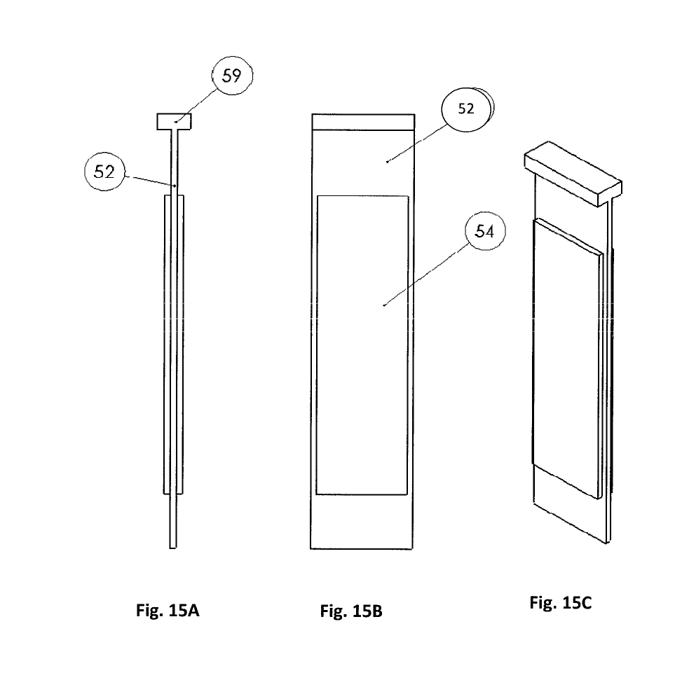

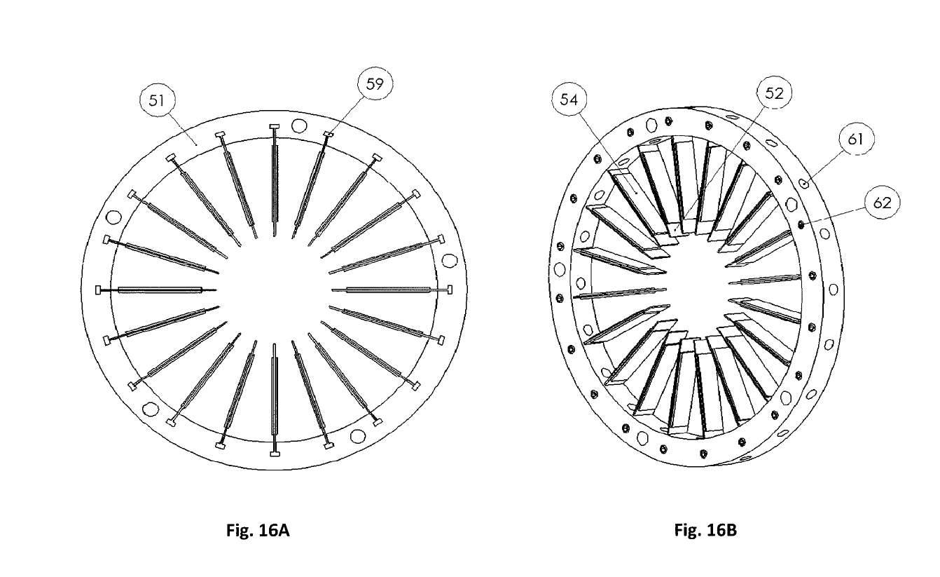

FIGS. 15A through 15C show the piezoelectric element 54, the piezoelectric plate 52 to which the piezoelectric element 54 is attached to, and an outer connecting unit 59. The piezoelectric element 54 is adhered to the piezoelectric plate 52 using an adhesive. Here, the piezoelectric plate 52 preferably comprises a durable material with elasticity and strength of a certain level.

FIG. 16 includes a silver piezoelectric element 54, the piezoelectric plate 52, the outer ring 51 of the piezoelectric element, an outer ring connecting unit 59, a wire fixing chamber 61, and a piezoelectric element fixing screw 62. The piezoelectric element 54 is attached to the piezoelectric plate 52 to be coupled with the outer ring 51. Here, the piezoelectric plate 52 is fit into the connecting outer unit 59 and is fixed by the piezoelectric element fixing screw 62. A wire connected to the piezoelectric element 54 is extracted through the wire fixing chamber 61 to complete the assembly.

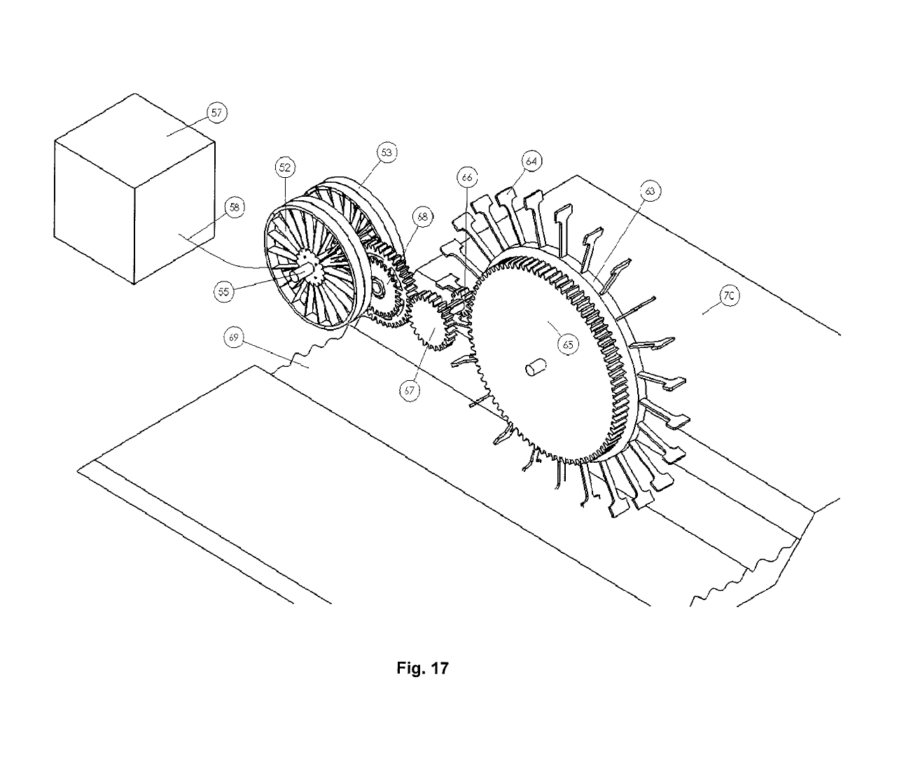

FIG. 17 shows a water plant that produces a power using water course such as, for example, river or waterfall. A watermill 63 and a watermill output gear 65 positioned thereon are provided. When water 69 flows downhill along a path formed by a water barrier 70, the water 69 hits a watermill blade 64, resulting in the watermill blade 64 rotating in the same direction the water 69 flows. Here, the watermill output gear 65 continues to have a rotary motion along with an intermediate transmission input gear 66. Accordingly, an intermediate transmission output gear 67 and a differential transmission system 68 are also rotated at a rate controlled by the number of teeth on the gear. In order to control the amount of electricity to be produced, the number of gear tooth can be adjusted to increase or decrease a rotational speed, i.e., revolutions per minute (RPM).

At least two output systems for producing electricity are provided, wherein each output system includes the outer ring 53, the piezoelectric element (not shown), the piezoelectric plate 52, and the gear vibrator 55. An axis of the gear vibrator 55 is continuously rotated to vibrate the outer ring 53 of the piezoelectric element, thereby generating electricity.

The produced electricity is provided to the power control box 57, which includes the PCU, the battery, the built-in sensor, the convertor, the power jack, and the diagnosis lamp. Specifically, the produced electricity is converted by the convertor of the power control box 57 and discharged to an outlet through the power jack to be charged.

The number of gears is determined according to a desired rotational speed of the watermill output gear 65 or a required amount of electricity to be produced.

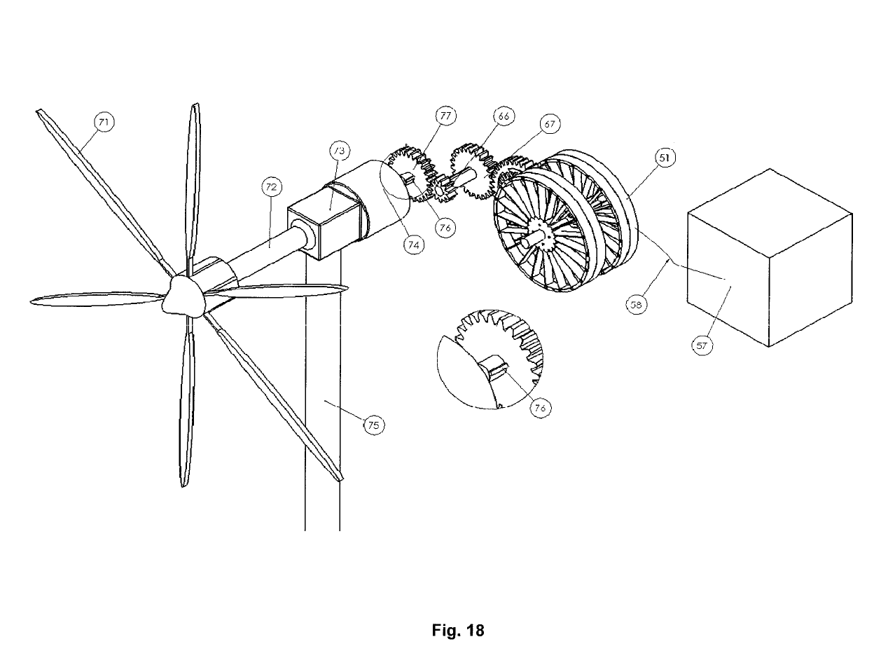

FIG. 18 is a perspective view of a wind power plant according to an exemplary embodiment of the present invention. The wind power plant of FIG. 18 includes a windmill blade 71, a windmill main shaft 72, a windmill housing 73 that supports the windmill shaft 72, a windmill gear box transmission and generator 74 for connecting the windmill shaft 72 and a windmill output gear 77, and a windmill column 75. While the windmill main shaft 72 of the wind power plant can be directly connected to the windmill output gear 77, in the exemplary embodiment of FIG. 18, the windmill main shaft 72 is connected to the windmill output gear 77 through a sensor 76. Thus, whenever the sensor 76 is rotated, electricity is produced and conveyed to the power control box 57 including the CPU, the Battery, the built-in sensor, the convertor, the power jack, and the diagnosis lamp. Accordingly, an electricity amount produced by an existing windmill can be doubled. The sensor 76 can be determined depending on the type of need.

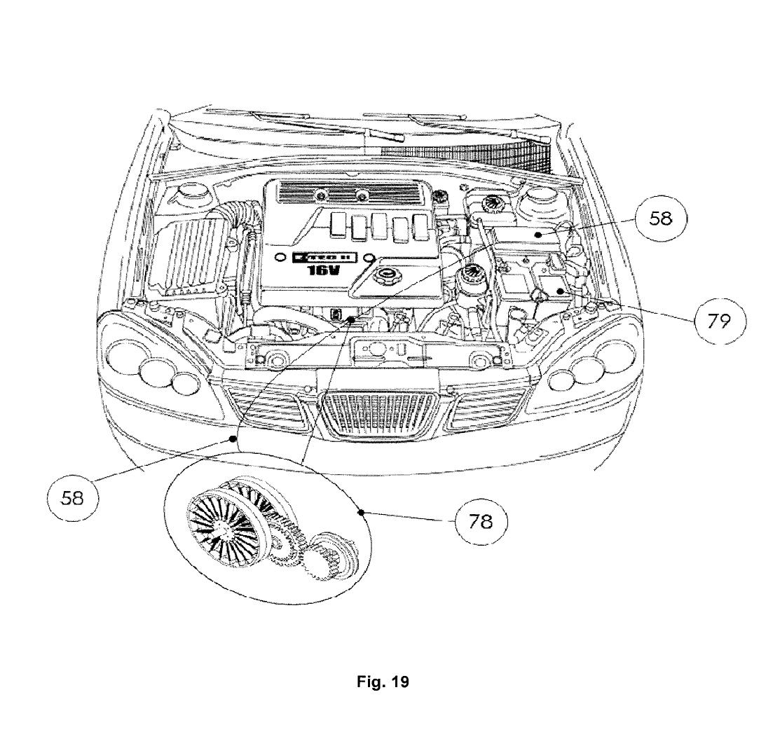

FIG. 19 shows a configuration of the mobile unit in which a portable power generator system 78 is connected to a power code 58 to charge the converted electricity into a battery 79. The portable power generator system 78 arid the battery 79 can be configured as shown in FIG. 1. Here, the motor 3 in FIG. 1 can be replaced by an auto part that has a circular or reciprocating motion inside a vehicle or can be replaced by the sensor 76. The motor 50 or the sensor 76 can be installed in appropriate locations inside a car or in a trunk.

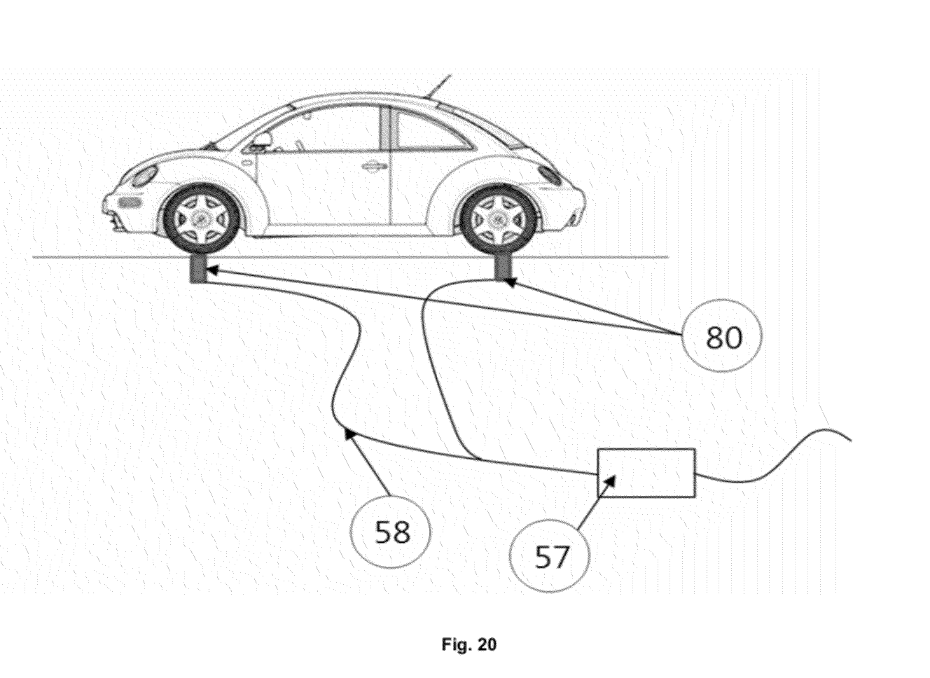

FIG. 20 shows a detection system using a sensor buried in a road. A sensor 80 buried in the road detects when the vehicle travels thereon, produces and converts electricity, and sends a signal through the electric power code 58 to the power control box 57 including the CPU, the battery, the built-in sensor, the convertor, the power jack, and the diagnosis lamp, to operate the portable generator system 78 so that the converted energy is charged in the battery 79.

An input stool 81 shown in FIG. 21 preferably comprises a durable material because the input stool 81 directly receives load or impact. For example, metal including iron that is easy to fabricate can be utilized. A push gear 82, a transmission input gear 84, a transmission output gear 83, a driver input gear/gear vibrator 55, and a driver outer ring 53 also preferably comprise a durable material with strength of a certain level. In FIG. 21, an example assembly order is as follows: the input stool 81 and the push gear 82 are first assembled, and then engaged with the transmission input gear 84, the transmission output gear 83, and the driver input gear/gear vibrator 55 that are adjacent thereto.

In an exemplary embodiment of FIG. 22A, a spring 85 is used to maximize vibration effects on the piezoelectric element 54 by placing the spring 85 beneath the road or sidewalk. In this manner, efficiency of electricity generation can be improved compared to a conventional method when installed in a road or sidewalk, especially when there is a lot of traffic.

FIG. 22B is a view illustrating an example in which a piezoelectric element is installed in a road according to an exemplary embodiment of the present invention and FIG. 22C is a view illustrating an example in which a piezoelectric element is installed in a sidewalk according to an exemplary embodiment of the present invention.

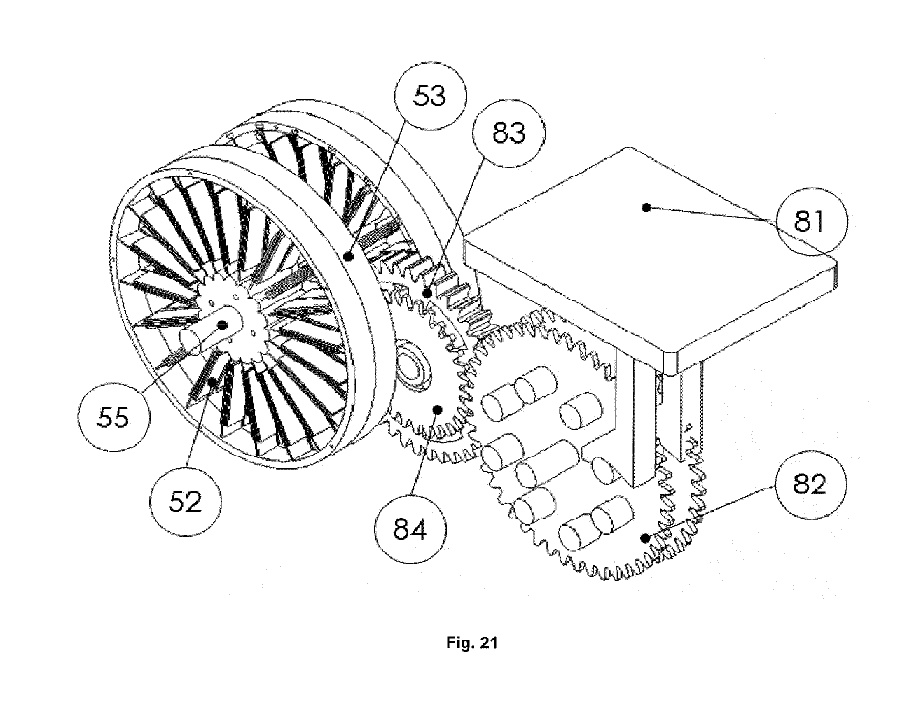

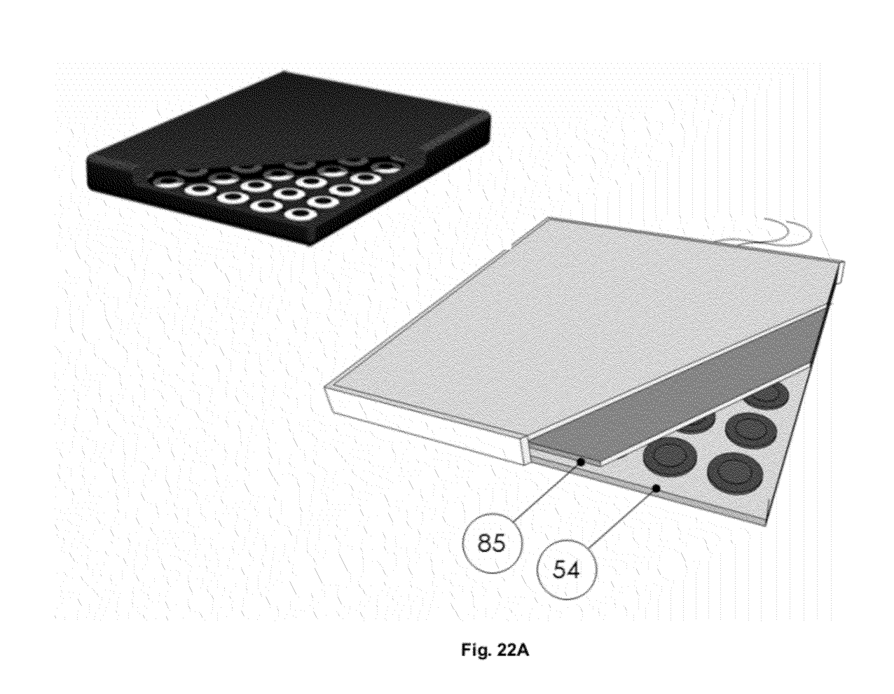

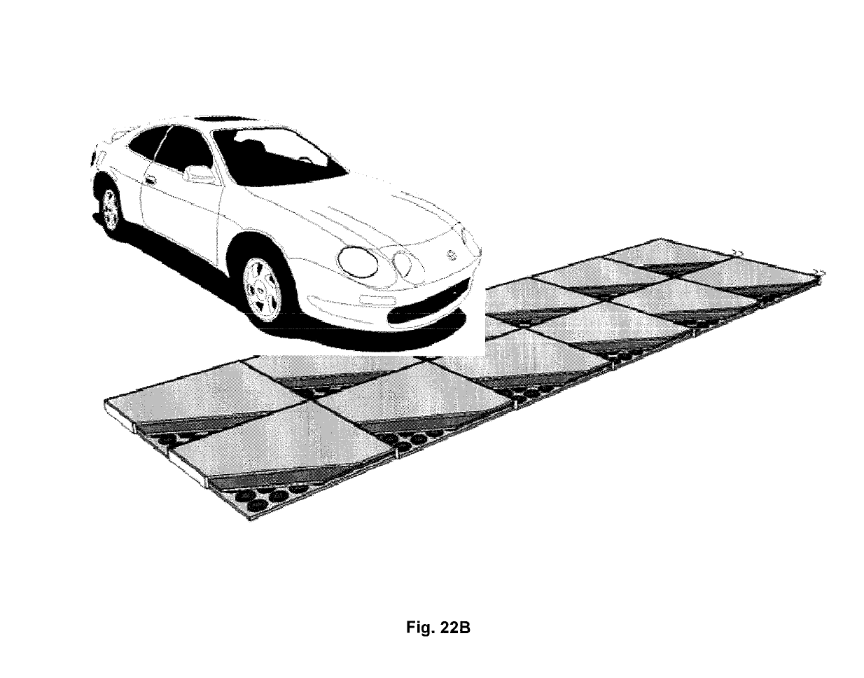

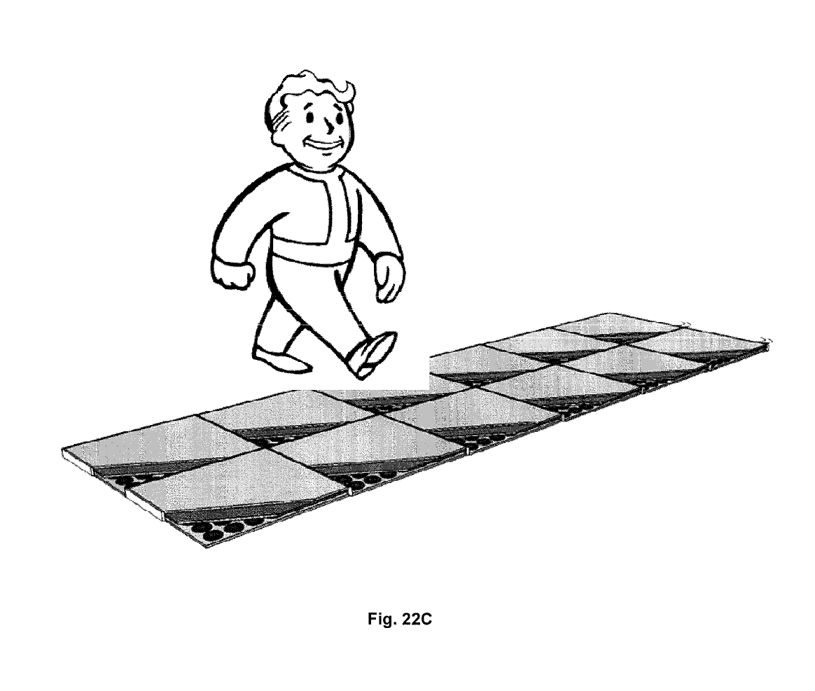

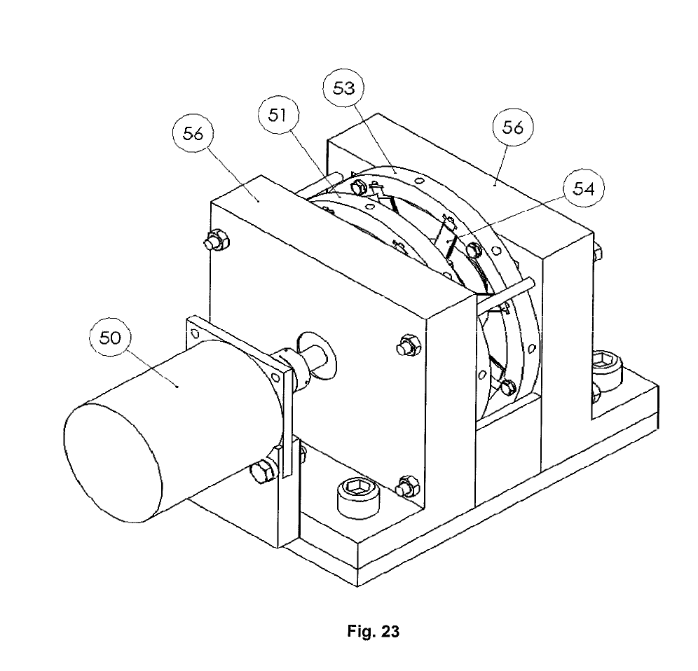

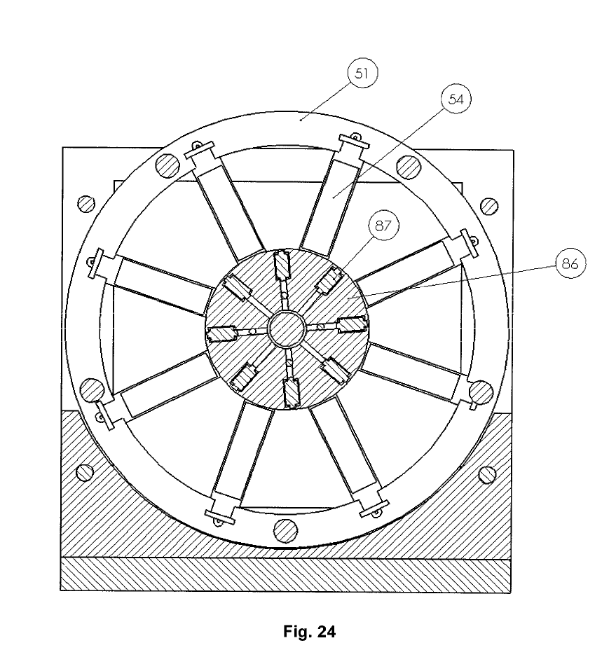

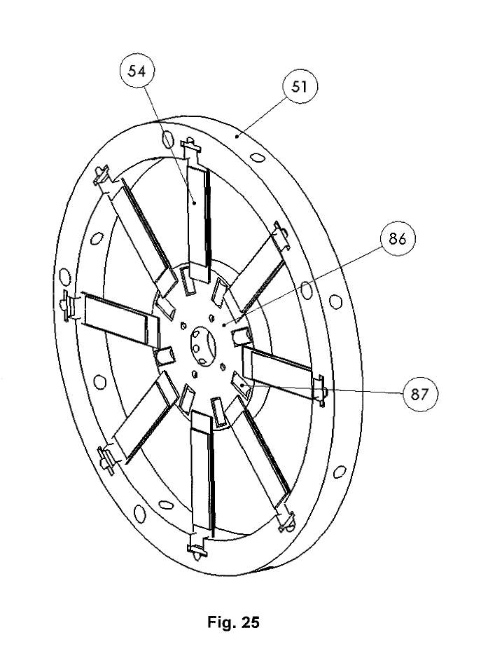

In FIGS. 23-25, the piezoelectric element 54 is installed in a direction perpendicular to the rotational axis, compared to the prior art in which the piezoelectric element is installed in a direction parallel to the rotational axis. Namely, when the needle disk 86 and the needle roller 87 rotate along the rotational axis, vibration applies to the piezoelectric element 54 in a direction perpendicular to the rotational axis.

In this approach, since the needle disk 86, the needle roller 87 and the piezoelectric element 54 move as one body, it is possible that the piezoelectric element 54 may not return to the original state during a period between applying a vibration impact to a first piezoelectric element 54 and applying the vibration impact to a second piezoelectric element.

To overcome such disadvantages, in the present invention, the needle disk 86, the needle roller 87 and the piezoelectric element 54 are provided as separate units.

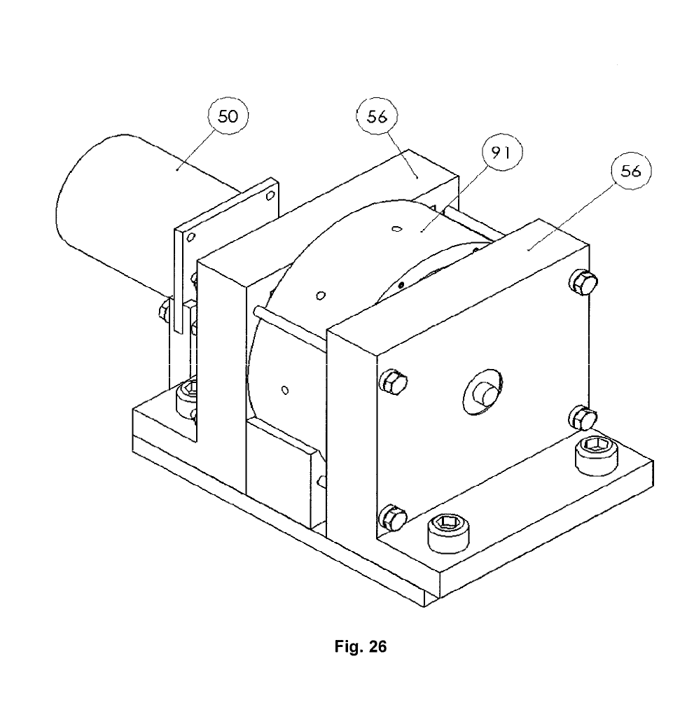

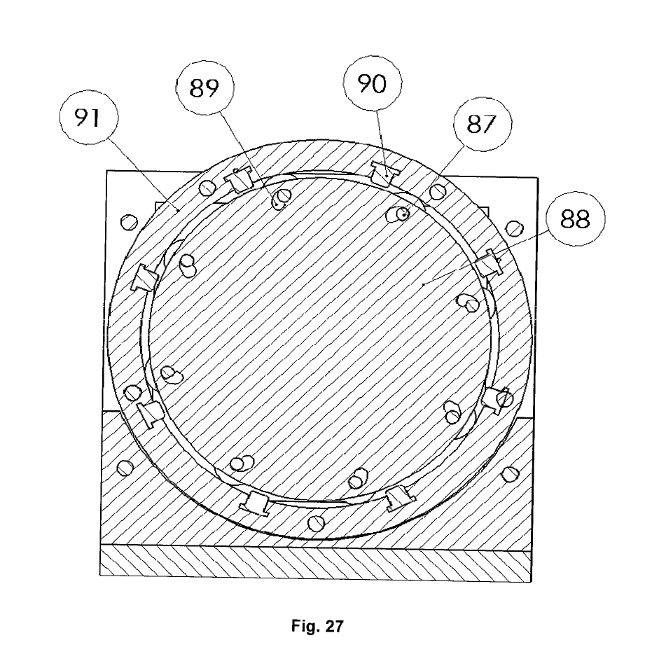

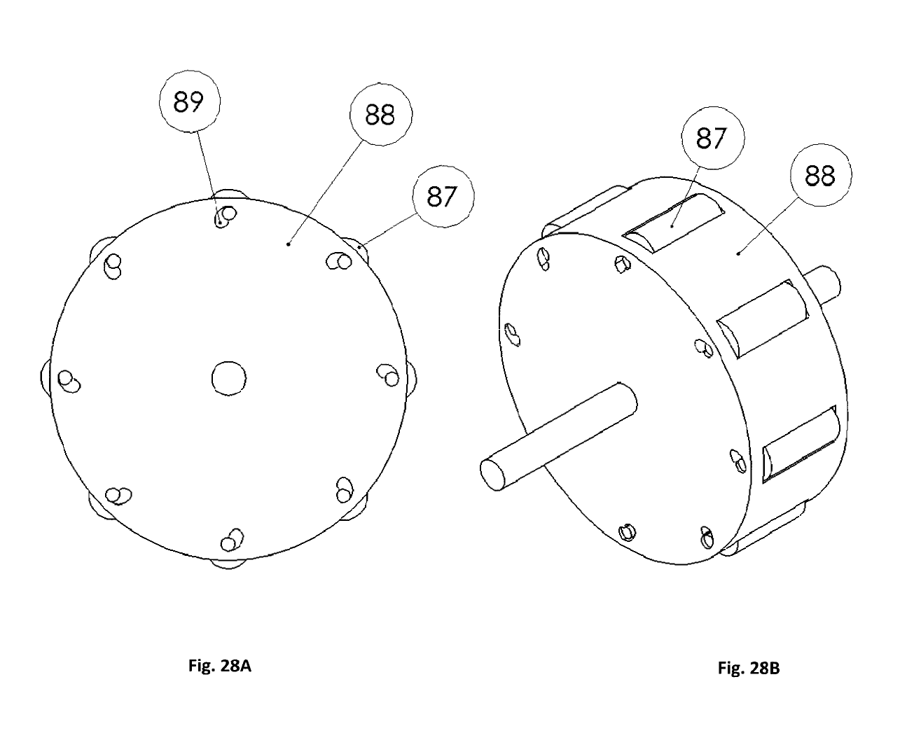

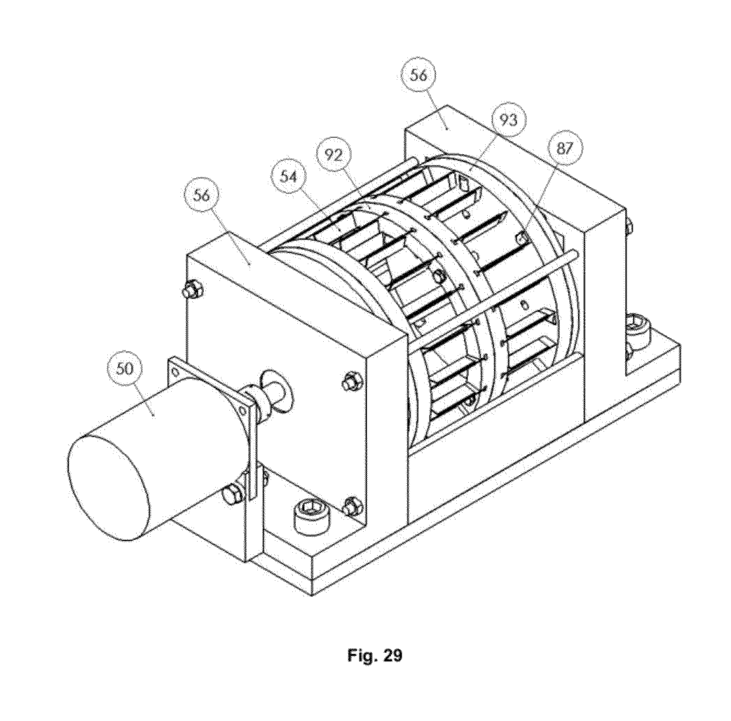

In FIGS. 26-28, the needle roller 87 moves within a centrifugal disk 88 so that, using a centrifugal force, pressure is directly applied to the centrifugal piezo 90, thereby producing electricity.

When the motor 50 is not in operation, the needle roller 87 is positioned in one end, i.e., a bottom portion of the centrifugal groove 89. When the motor 50 starts rotating, a centrifugal force is generated such that the needle roller 87 is pushed outwardly from a center of the centrifugal disk 88, i.e., toward the other end of the centrifugal groove 89.

Here, a direct pressure is applied to the centrifugal piezo 90 positioned on a centrifugal outer ring 91 by a rolling motion of the needle roller 87 inside the centrifugal outer ring 91, thereby generating electricity.

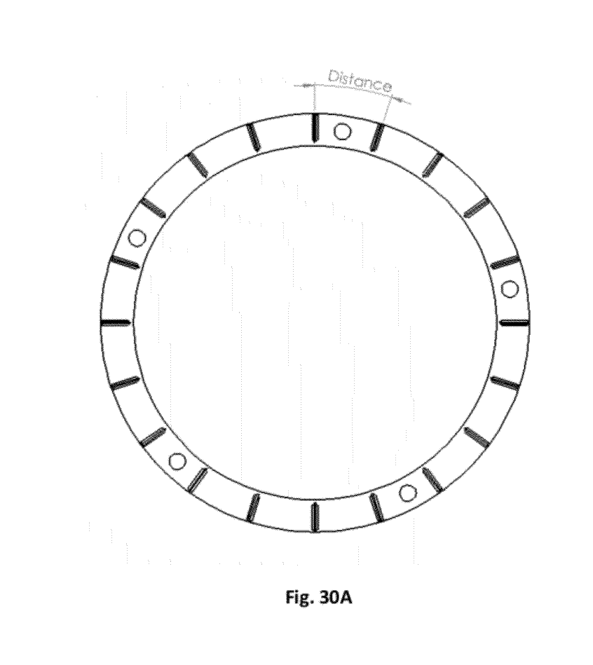

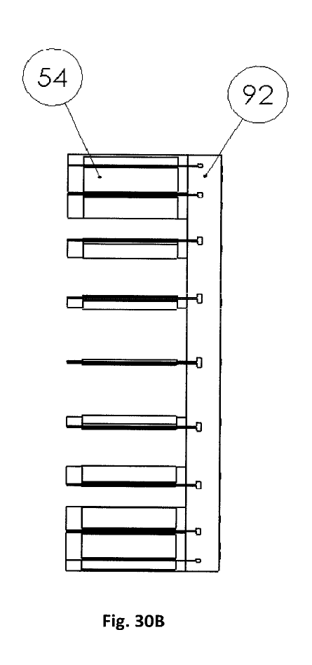

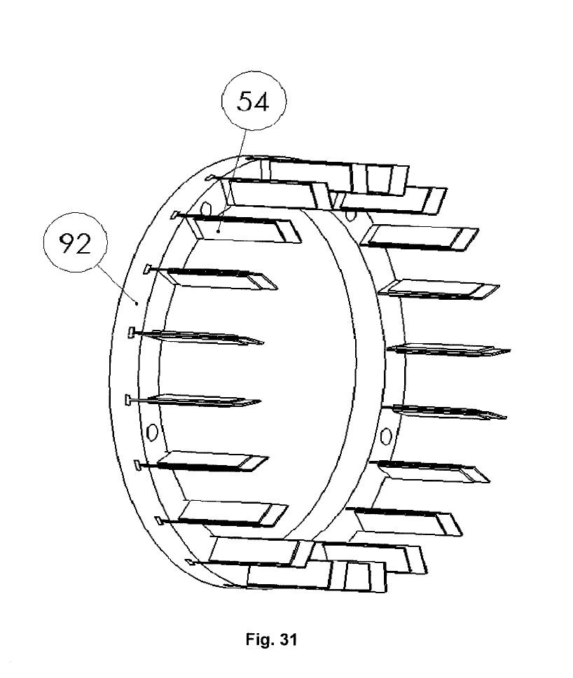

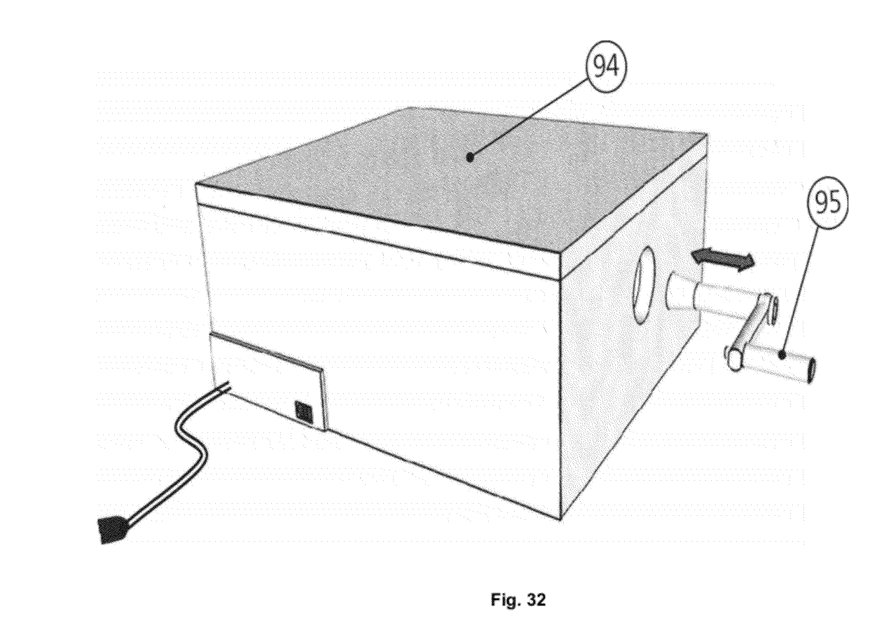

FIGS. 29-31 show a portable power generator using a turret. A turret outer ring 92 is located in the center with respect to the outer rings 51, wherein the piezoelectric element 54 is arranged along an axis thereof. The arrangement of the piezoelectric element 54 is different from the prior art in that an interval between the piezoelectric elements is constant whether it is toward the outer ring 51 or toward the turret outer ring 92, thereby providing sufficient space to accommodate additional piezoelectric elements 54, as many as needed.

The piezoelectric elements 54 spaced apart from each other at a constant interval are mounted to the turret outer ring 92. When the motor 50 rotates, the needle roller 87, which is formed on the turret disk 93 at a predetermined interval, also rotates to vibrate the piezoelectric elements 54 to produce electricity.

FIG. 32 is a view illustrating a portable power generator box 94 and a handle 95 according to the exemplary embodiment of the present invention.

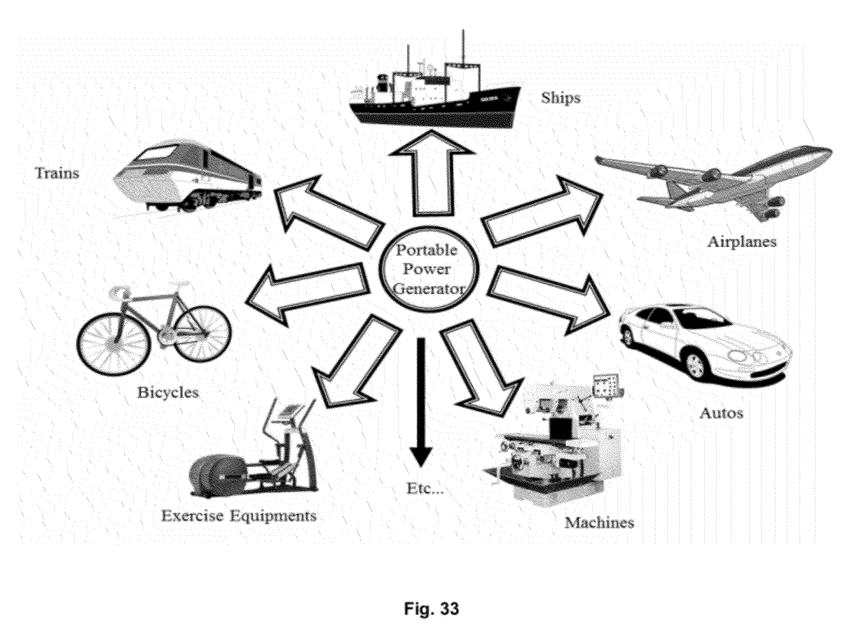

FIG. 33 is a view illustrating various applications of a power generator according to an exemplary embodiment of the present invention.

In the exemplary embodiments of the power generator system described in the above, the handle 95 can be connected to the system when the motor breaks down or there is no energy source, for example, hydraulic power so that electricity can be generated by a manual operation of the handle 95.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

LIST OF REFERENCE NUMERALS

| | |
|---|---|
| 1: Motor Fixing Support | 2: Bearing |
| 3: Motor | 4: Piezoelectric Element Fixing |
| | Support |
| 5: Piezoelectric Element | 6: Sub Fixing Support |
| 7: First Fixing Bolt | 8: First Fixing Nut |
| 9: Lower Fixing Support | 10: Motor Fixing Bolt |
| 11: Coupling | 12: Snap Ring |
| 13: Coaxial Axis Fixing Bolt | 14: Coaxial Axis Fixing Nut |
| 15: Motor Fixing Nut | 16: Eccentric Disk |
| 17: Coaxial Axis Fixing and | |
| External Connecting Road | |
| 18: Piezoelectric Element Fixing | |
| Spring | |
| 19: Spring Fixing Bolt | |
| 20: Coaxial Axis Fixing and | |
| Internal Connecting Road | |
| 21: Lower Portion Fixing Bolt | |
| 22: Urethane Outer Ring | 23: Needle Bearing Piezo Outer Ring |
| 24: Needle Bearing Pizeo | 25: Needle Bearing |
| 26: Needle Bearing Pizeo Disk | 27: Needle Bearing Pizeo Disk Shaft |
| 28: Cam Fixing Support | 29: Piezo |
| 30: Cam Disk | 31: Piezoelectric Element Fixing |
| | Plate |
| 32: Flywheel | 33: Connecting Rod (1) |
| 34: Connecting Rod (2) | 35: Handle |
| 36: Power Drawer Main Box | 37: Power Drawer Cover Top |
| 38: Roller | 39: Vibration Plate |
| 40: Piezoelectric Plate | |
| 41: Control Box (Including | |
| Convertor, Sensor, Battery) | |
| 42: Power Plug | 43: Power Jack |
| 44: Charge Green Light | 45: Charge Red Light |
| 46: Switch | 47: PCB(CPU) |
| 48: Antenna | 49: External Connection Jack |
| 50: Motor | 51: Outer Ring (1) |
| 52: Piezoelectric Plate | 53: Outer Ring (2) |
| 54: Piezoelectric Element | 55: Gear Vibrator |
| 56: Outer Ring Holder | |
| 57: Power Control Box (Including | |
| Convertor, Sensor, Battery) | |
| 58: Power Code | 59: Outer Connecting Unit |
| 61: Wire Fixing Chamber | 62: Piezoelectric Element Fixing |
| | Screw |
| 63: Watermill | 64: Watermill Blade |
| 65: Watermill Output Gear | 66: Intermediate Transmission Input |
| | Gear |
| 67: Intermediate Transmission | |
| Output Gear | |
| 68: Differential Transmission | |
| System | |
| 69: Water | 70: Water Barrier |
| 71: Windmill Blade | 72: Windmill Main Shaft |
| 73: Windmill Housing | 74: Windmill Gear Box Transmission |
| | & Generator |
| 75: Windmill Column | 76: Sensor |
| 77: Windmill Output Gear | 78: Portable Power Generator System |
| 79: Battery | 80: Sensor |
| 81: Input Stool | 82: Push Gear |
| 83: Transmission Output Gear | 84: Transmission Input Gear |
| 85: Spring | 86: Needle Disk |
| 87: Needle Roller | 88: Centrifugal Disk |
| 89: Centrifugal Groove | 90: Centrifugal Piezo |
| 91: Centrifugal Outer Ring | 92: Turret Type Outer Ring |
| 93: Turret Type Disk | 94: Power Generator System Box |
| 95: Handle | |

What is claimed is:

1. A system for producing electricity, the system comprising:
an object configured to move in at least one of, an upward direction, a downward direction, a left direction, a right direction, an eccentric motion, a straight line, or a circular motion; and
at least one piezoelectric element attached to the object,
wherein, when the object is moving, the object is configured to apply a pressing force to the at least one piezoelectric element to produce the electricity.

2. The system according to claim 1, wherein the object has a shape of one of, a polygon or a circle.

3. The system according to claim 2, further comprising:
a spring attached to the at least one piezoelectric element,
wherein, when the at least one piezoelectric element receives the pressing force that is greater than a threshold level, the spring absorbs an excessive force.

4. The system according to claim 1, further comprising:
a gear connected to the object,
wherein, when the object is moving, a rotation ratio of the gear is controlled to increase or decrease a rotational speed of the object.

5. The system according to claim 1, further comprising:
a sensor configured to automatically turn on or turn off the system.

6. A system for producing electricity, the system comprising:
a first plate;
at least one piezoelectric element attached to the first plate;
a vibrator; and
a second plate attached to the vibrator,
wherein the second plate is positioned above or below the first plate and is configured to move in at least one of, a forward direction, a backward direction, a left direction, or a right direction such that the vibrator is configured to apply a pressing force to the at least one piezoelectric element to produce the electricity.

7. The system according to claim 6, wherein the second plate comprises a roller, and
wherein the second plate is configured to move in at least one of, the forward direction, the backward direction, the left direction or the right direction by using the roller.

8. The system according to claim 6, wherein the second plate is configured to move by a manual or mechanical operation.

9. The system according to claim 8, further comprising:
a handle attached to the second plate and configured to enable the manual operation of the second plate.

10. The system according to claim 6, wherein the first plate comprises a pin type electrical printed circuit board (PCB), and the at least one piezoelectric element is attached or detached to/from the PCB of the first plate.

11. The system according to claim 6, further comprising:
a control box having a battery configured to store the produced electricity.

12. The system according to claim 11, wherein the control box has a sensor to monitor a battery level, and when the battery level is lower than a predetermined threshold level, the system is configured to automatically turn on to produce the electricity.

13. The system according to claim 12, further comprising:
at least one power connector jack configured to discharge the produced electricity.

14. The system according to claim 11, wherein the control box includes a central processing unit configured to automatically control an electric power level of the battery such that, when the electric power level of the battery is lower than a predetermined level, a red light emitting diode (LED) light is turned on, a warning sound is generated, and the battery starts charging.

15. The system according to claim 14, wherein at least one of, a text, an e-mail, or a voice message is sent to a mobile phone or a reachable device designated by a user to notify the user that the battery is being charged.

16. The system according to claim 14, wherein, when charging of the battery is completed, the central processing unit is configured to turn on a green LED light.

17. The system according to claim 16, wherein at least one of, a text, an e-mail, or a voice message is sent to a mobile phone or a reachable device designated by a user to notify the user that the charging of the battery is completed.

18. The system according to claim 6, further comprising:
a power drawer main box configured to receive the first plate; and
a motor connected to the power drawer main box through a connecting rod,
wherein, when the motor is driven, the power drawer main box is caused to move with respect to the second plate, thereby applying at least one of, a pressure, an impact or a vibration to the piezoelectric element that is attached to the first plate.

19. A system for producing electricity, the system comprising:
a first needle disk;
a second needle disk;
a motor;
a disk roller positioned between the first needle disk and the second needle disk, the disk roller being connected with the motor; and
a piezoelectric element attached to the first needle disk and the second needle disk,
wherein, when the disk roller is rotated by an operation of the motor, a pressure is applied to the piezoelectric element to produce the electricity.

20. The system according to claim 19, further comprising:
a sensor configured to automatically turn on or turn off the system.

21. The system according to claim 19, wherein the piezoelectric element is positioned perpendicular to a rotation axis such that the first needle disk and the second needle disk, the disk roller and the piezoelectric element are rotated together.

22. A system for producing electricity, the system comprising:
an upper plate;
a lower plate;
a motor;
a piezoelectric element attached to the upper plate and the lower plate;
a cam disk positioned between the upper plate and the lower plate, the cam disk being connected to the motor; and
a needle bearing positioned on an end portion of the cam disk,
wherein the needle bearing presses the piezoelectric element to produce the electricity when the motor is rotated.

23. The system according to claim 22, further comprising:
a spring positioned on the upper plate and the lower plate, the spring being configured to control a pressure level applied thereto.

24. The system according to claim 22, further comprising:
a sensor configured to automatically turn on or turn off the system.

25. A system for producing electricity, the system comprising:
a piezoelectric element configured to be installed on a road or sidewalk; and
a spring configured to be positioned between the piezoelectric element and the road or the sidewalk to increase a vibration force applied to the piezoelectric element when the road or the sidewalk is pressed by a vehicle or a pedestrian.

26. A system for producing electricity, the system comprising:
a motor;
a centrifugal disk having a centrifugal groove and is connected to a rotation axis of the motor;
a centrifugal outer ring;
a needle roller positioned on the centrifugal disk, wherein the needle roller is moved along the centrifugal groove when the motor is rotated; and
a piezoelectric element positioned on the centrifugal outer ring,
wherein a pressing force is applied to the piezoelectric element by a rolling motion of the needle roller to generate electricity.

27. A system for producing electricity, the system comprising:
an outer ring;
piezoelectric elements;
a turret disk;
a turret outer ring located in the center of the outer ring, wherein the piezoelectric elements are arranged on the turret outer ring along a circumference of the turret outer ring and the piezoelectric elements are positioned at a constant distance from each other both toward the outer ring and toward the turret outer ring; and
a needle roller located at a predetermined distance on the turret disk, wherein the needle roller is rotated by a motor to vibrate the piezoelectric elements, thereby generating the electricity.

28. A method of producing electricity, the method comprising:
providing a piezoelectric element;
providing an object that is configured to move in at least one of, an upward direction, a downward direction, a left direction, a right direction, an eccentric motion, a straight line, or a circular motion,
connecting the piezoelectric element to the object;
moving the object such that a pressing force is applied to the piezoelectric element; and
producing electricity.

29. The method according to claim 28, further comprising:
providing an outer ring having an inner wall;
installing the piezoelectric element on the inner wall of the outer ring; and
moving the outer ring in an eccentric rotary motion.

30. The method according to claim 28, further comprising:
storing the produced electricity in a battery.

31. The method according to claim 28, further comprising:
providing a number of gear teeth configured to rotate the object,
wherein, when the object moves in the circular motion, the number of gear teeth is adjusted to increase or decrease a rotational speed of the object to control an amount of the produced electricity.

32. The method according to claim 28, wherein the object is moved by using hydroelectric power.

33. The method according to claim 28, wherein the object is moved by using wind power.

34. The method according to claim 28, further comprising:
providing a sensor; and
automatically detecting, by using the sensor, an amount of electricity consumption to control an operation of the object.
